(19) United States
(12) Patent Application Publication
(10) Pub. No.: US 2006/0245751 A1
(43) Pub. Date: Nov. 2, 2006

(54) Camera having functions of copying and moving images by one single operation

(75) Inventors: Shiro Nagaoka, Ome-shi (JP); Tatsuhiko Ikehata, Ome-shi (JP); Kei Tashiro, Ome-shi (JP); Tatsuro Abe, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/402,828

(22) Filed: Apr. 13, 2006

(30) Foreign Application Priority Data
Apr. 28, 2005 (JP) 2005-133401

(51) Int. Cl. G03B 17/00

(52) U.S. Cl. 396/439

(57) ABSTRACT

A camera apparatus of one embodiment of the invention, a recording area including a recording capacity corresponding to a recording capacity of a semiconductor memory is detachable from or preliminarily built in the camera apparatus or a record medium prepared in an externally connected recorder, is provided in a recording area of a hard disk drive. Data groups stored in the recording area including a recording capacity set to be at most the recording capacity of the new recording area corresponding to the semiconductor memory prepared in the externally connected recorder, able to be transferred to the semiconductor memory or the externally connected recorder, by one operation, as a single unit of the data group stored in the new recording area.

### CROSS-REFERENCE TO RELATED APPLICATIONS

This application is based upon and claims the benefit of priority from prior Japanese Patent Application No. 2005-133401, filed Apr. 28, 2005, the entire contents of which are incorporated herein by reference.

### BACKGROUND

1. Field

One embodiment of invention relates to a method of transferring images picked up by a camera apparatus capable of recording still images and moving images to an arbitrary recorder or record medium, and a camera apparatus capable of the transfer.

2. Description of the Related Art

A camera apparatus is capable of recording still images and moving images to a record medium such as a semiconductor memory (memory card), a hard disk drive (HDD), etc.

In response to user operations of the camera apparatus or a transfer request from a management device (personal computer), an external record device, etc. connected to the camera apparatus, the images can be transferred (recorded) to a record medium such as a large-capacity HDD, optical disk, a memory card, etc. inside the management device (or via the management device)

Japanese Patent Application Publication (KOKAI) No. 2004-165852 discloses a digital still camera capable of transferring image via the Internet.

In an image transfer method disclosed in the Publication 2004-165852, a data group of moving images, still images, etc. to be transferred needs to be visually recognized and selected by the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary schematic view showing a camera apparatus capable of recording moving images, still images, voice, etc. according to an embodiment of the present invention;

FIG. 1B is an exemplary schematic view showing the camera apparatus capable of recording moving images, still images, voice, etc. according to the embodiment of the present invention;

FIG. 2 is an exemplary view showing a connection between the camera apparatus shown in FIGS. 1A and 1B and an external record device;

FIG. 3 is an exemplary block diagram showing a control system of the camera apparatus shown in FIGS. 1A and 1B;

FIG. 4 is an exemplary diagram showing a configuration of a recording area of the camera apparatus shown in FIGS. 1A, 1B and FIG. 3;

FIG. 5 is an exemplary diagram showing a configuration of a recording area of the camera apparatus shown in FIGS. 1A, 1B and FIG. 3;

FIG. 6 is a flowchart exemplary showing a method of transferring data group recorded in the recording area shown in FIG. 4 or 5; and

FIG. 7 is a flowchart exemplary showing another method of transferring data group recorded in the recording area shown in FIG. 4 or 5.

### DETAILED DESCRIPTION

Various embodiments according to the invention will be described hereinafter with reference to the accompanying drawings. In general, according to one embodiment of the invention, a camera apparatus of one embodiment of the invention, a recording area including a recording capacity corresponding to a recording capacity of a semiconductor memory is detachable from or preliminarily built in the camera apparatus or a record medium prepared in an externally connected recorder, is provided in a recording area of a hard disk drive. Data groups stored in the recording area including a recording capacity set to be at most the recording capacity of the new recording area corresponding to the semiconductor memory prepared in the externally connected recorder, able to be transferred to the semiconductor memory or the externally connected recorder, by one operation, as a single unit of the data group stored in the new recording area.

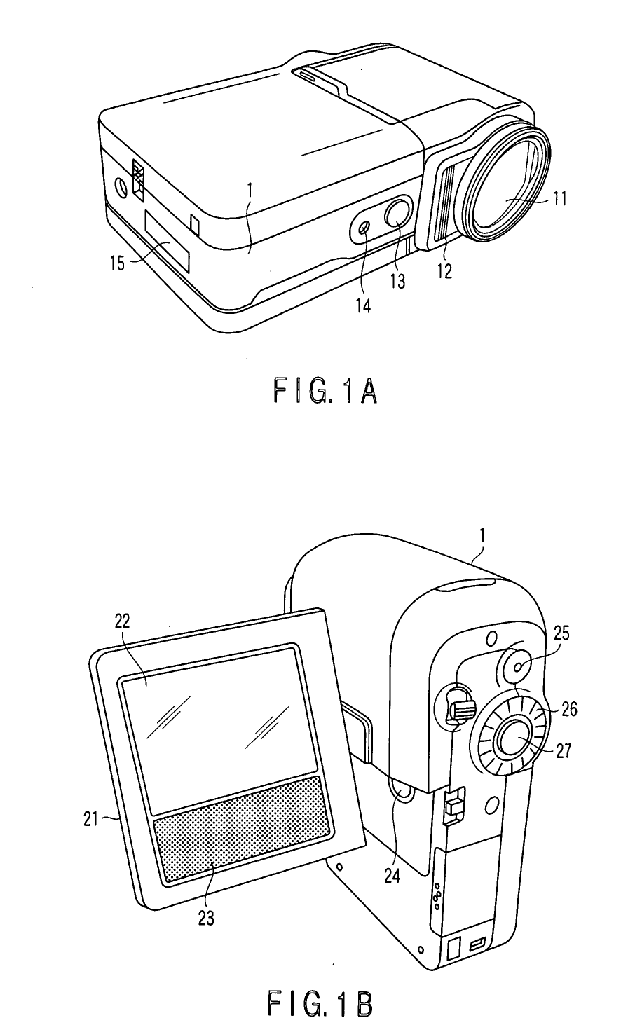

FIG. 1A and FIG. 1B schematically show a camera apparatus capable of recording moving images, still images, audio/sound, etc. according to an embodiment of the invention. FIG. 1A shows an electronic camera apparatus (image pickup device) 1 seen from an image pickup lens side.

The electronic camera apparatus 1 includes an image pickup lens 11, a flash 12, a shutter button 13 and a remote-control receiver 14 (for taking still images), etc. The electronic camera apparatus 1 also includes an adapter connector (connection terminal) 15 used for connection with a personal computer, an external power supply device (AC adaptor), etc.

FIG. 1B shows an electronic camera apparatus (image pickup device) 1 seen from a side opposite to the image pickup lens 11 side.

The camera apparatus 1 further includes a liquid crystal monitor (LCD panel) 22 and a speaker 23 which are integrally embedded in a frame 21 serving as a main power supply switch. The camera apparatus 1 still further includes a main power switch 24 at a predetermined position of the camera apparatus body hidden by a frame 21 when the frame 21 is closed.

Moreover, a record button 25 for inputting instructions (control commands) to start and stop (end) recording moving images, a jog dial 26 for inputting instructions (control commands) to select input and OK instructions about operation modes and various conditions, an OK button 27 for inputting instructions (control commands) to confirm (execute) the instruction selected (guided) by the jog dial 26, etc. are provided at predetermined positions of the camera apparatus 1. The OK button 27 is positioned, for example, coaxially (concentrically) about the rotation of the jog dial 26.

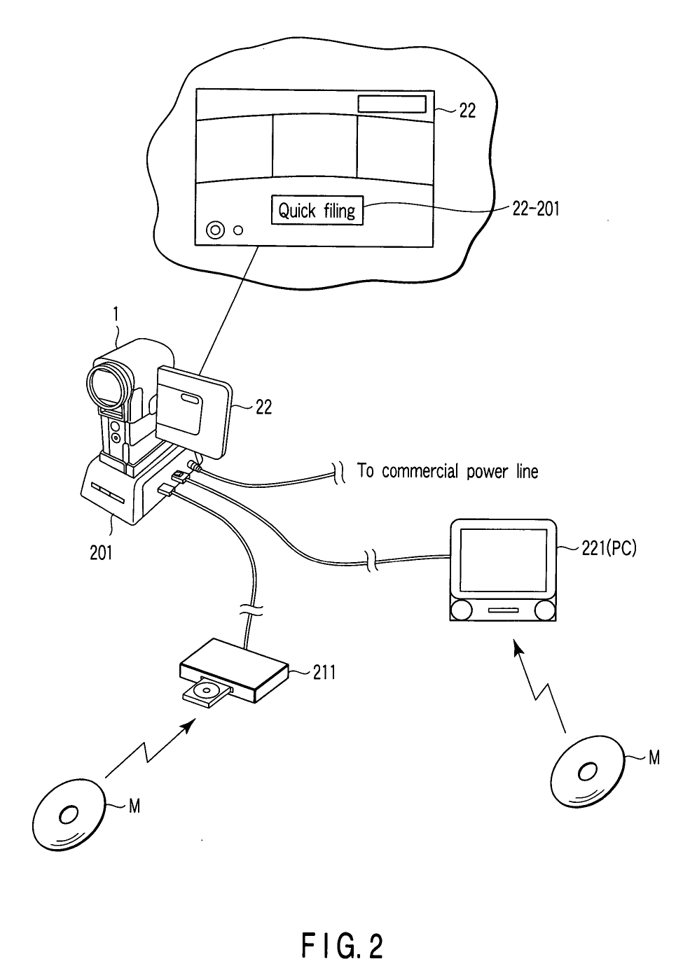

The camera apparatus 1 is connected to an arbitrary number/plural kinds of external recorders, for example, a writer 211 using DVD-R disks and CD-R disks as record mediums M and a personal computer (PC) 221, by cables or radio signals, via an extended connector (cradle) 201 (not described) which is connected to the adapter connector 15. In accordance with an instruction of transfer from the camera apparatus 1, image data (data group) retained in the camera apparatus 1 can be transferred (FIG. 2). In addition, a transfer instruction device (“Quick filing mechanism”) capable of transferring the image data (data group) retained in the camera apparatus 1, by one single operation, in accordance with the instruction of transfer sent from the camera apparatus 1, is provided in the camera apparatus 1 though it is described later in detail.

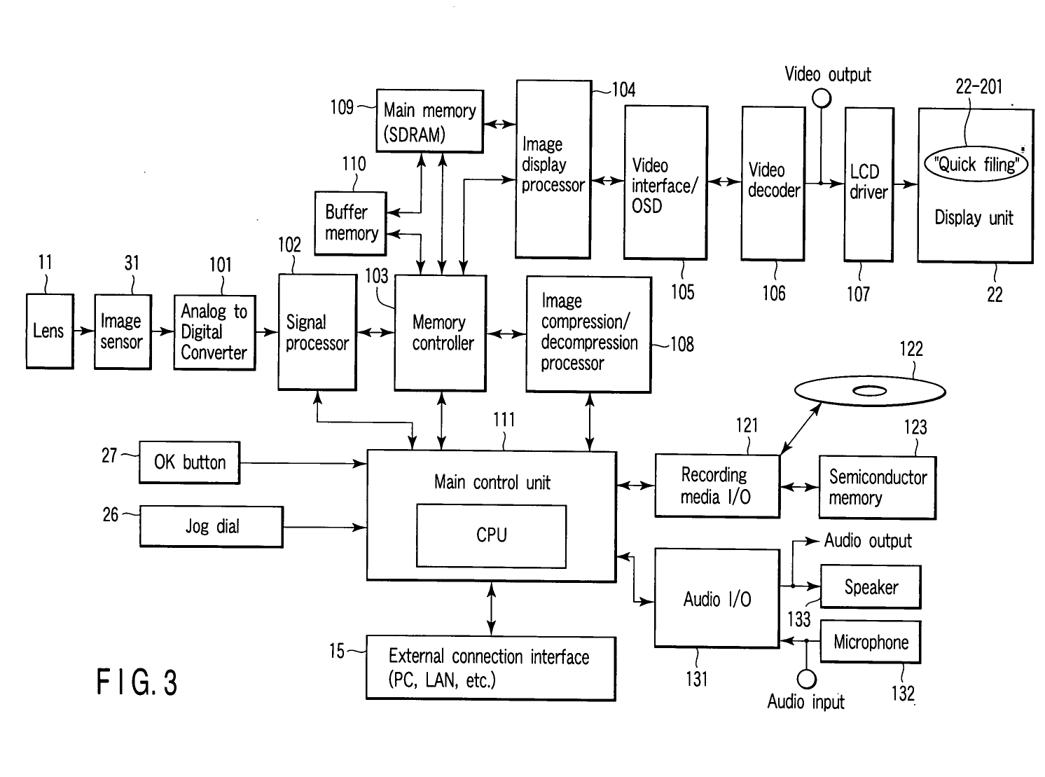

FIG. 3 shows a control system of the camera apparatus shown in FIG. 1A and FIG. 1B.

An object image captured through the image pickup lens 11 is formed on an image-picking up surface of an image sensor 31 which is, for example, a CCD sensor and converted into an analog signal (image data). The object image is converted into an electric signal on the based on light and shade, by the image sensor (CCD sensor) 31. The electric signal is converted, by an analog-digital (A/D) converter 101, into a digital signal, which is input to a signal processor 102.

In the signal processor 102, the image data converted into the digital signal by the A/D converter 101 is subjected to processing such as gamma correction, chrominance signal separation, white balance calibration, etc.

The image data output from the signal processor 102 is supplied to an image display processor 104 via a memory controller 103. The image display processor 104 generates an image signal, i.e. a video signal for display output.

In a video interface/on-screen-display (OSD) processor 105, a display corresponding to “Quick filing” icon (button) 22-201 used for the input of the signal which permits execution of “Quick filing” as schematically shown in FIG. 2 is created and synthesized, on the LCD panel (hereinafter simply called LCD) 22 (FIG. 1B) mounted on the frame 21.

An output of the video decoder 106 is input to an LCD driver 107 and displayed on the LCD 22 by the LCD driver 107.

At the recording time of the image data output from the signal processor 102, it is compressed by a compression/decompression unit 108, and recorded in a main record medium such as a hard disk drive (HDD) 122 or a detachable record medium such as a memory card 123 which is a nonvolatile memory, via a record media controller 121, under control of a main control unit (CPU) 111.

As the memory card 123, for example, a semiconductor memory (SD record medium) called SD card (TM) or mini-SD (TM) can be used. Needless to say, for example, the HDD 122 can be replaced with an optical disk. In the compression/decompression unit 108, a still image is compressed in a well-known compression scheme of JPEG standard or the like and a moving image (non-still image) is compressed in a well-known compression scheme of MPEG standard or the like.

The capacity of the HDD 122 is approximately ten times as great as the capacity of, for example, a widely spread DVD-recordable (DVD-R) disk. Therefore, the recording capacity of the SD record medium 123 is smaller than that of the HDD 122.

When the image recorded in the HDD 122 or memory card 123 is reproduced, the image read from the HDD 122 or memory card 123 is decompressed by the compression/decompression unit 108, supplied to the image display processor 104 through the main controller 103, and displayed on the LCD 22.

In the image display processor 104, reduction of the size of the image data (creation of a thumbnail image), edition in an edition mode, change of the sequence of the image files, etc. are executed by a main memory (memory circuit, for example, SDRAM) 109 and a buffer (work) memory 110 which are connected to the memory controller 103, though not described in detail. The buffer memory 110 can store image data of one or plural screens. Since the image data stored in the buffer memory 110 is input to the image display processor 104 via the memory controller 103, the image data can be sequentially reproduced on the LCD 22, i.e. the image edition state can be confirmed on the LCD 22.

At the editing time or photographing time, audio/sound data can be input from a microphone 132 or audio input terminal connected to a voice input/output unit 131. The voice data is recorded in a predetermined area of the HDD 122 or memory card 123 in association with the image data.

When images are reproduced, the recorded voice data is read from the HDD 122 or memory card 123 together with the image data and output from a speaker 133 or audio output terminal as voice output. At the reproducing time, the voice output from the speaker 133 can be mute (i.e. output level can be set at “0”).

Incidentally, in the HDD 122 serving as the record medium, the number of still images to be recorded and the number of titles of the moving images range from hundreds to thousands. The titles of the moving images use the capacity of the HDD 122 corresponding to the recording time of the moving images. For this reason, it is necessary to increase the speed of fast-forwarding and rewinding (and/or skips) of the recorded images and titles.

The jog dial 26 and OK button 27 permit selection of many images or titles and setting of operation modes without a stress. (An easy-to-use switch such as the jog dial 26 is useful when specifying an image by continuously searching many images or titles.) The contents input by the jog dial 26 (by the user's operation), operation states of the camera apparatus 1, or display of the menu screen by the menu button 29 are combined through the CPU 111, memory circuit 109, image display processor 104, video interface and OSD processor 105, and displayed in the LCD 22.

The OK (set) button 27 gives the CPU 111 information that the button 27 is pressed (on/off signal is input). Based on the on/off signal input from the information (the button 27), the CPU 111 determines the image/title or mode selected by the jog dial 26, and plays the image/title or sets the mode.

The jog dial 26 gives the CPU (main control unit) 111 information about the rotation angle and speed. The CPU 111 can control the (next) image display speed from the information.

The OK (set) button 27 is placed coaxially (concentrically) with the center of rotation of the job dial 26. The OK (set) button 27 can input the above-mentioned ON signal when pressed substantially toward the center (in the axial direction), and can input a control command (instruction) to scroll an image displayed in the LCD 22 in the pressed direction, when pressed in one of four directions (generally called “up/down/left/right”) dividing the circumference equally into four parts.

Next, a characteristic configuration of the camera apparatus according to an embodiment of the invention and an image data processing method in the camera apparatus will be explained.

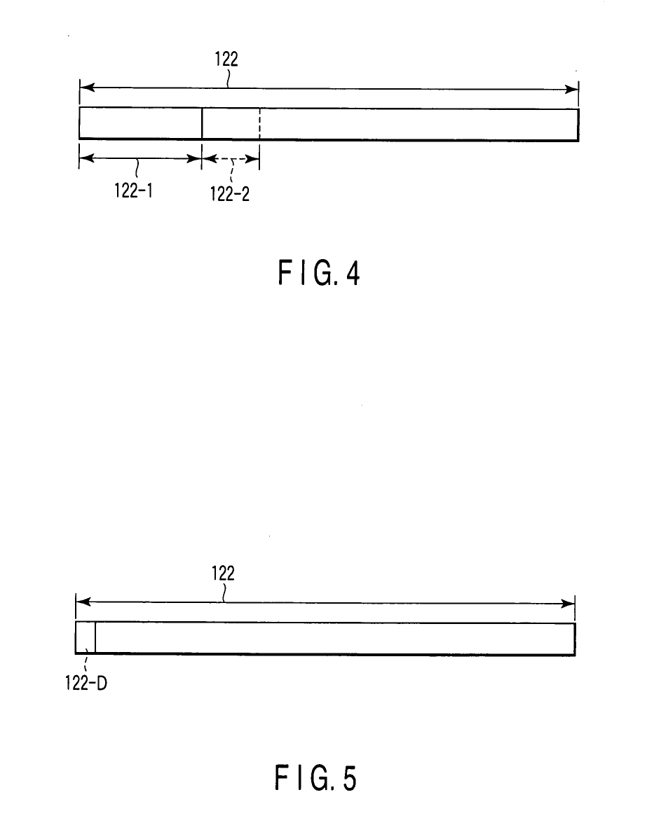

FIG. 4 shows a data recording area in an HDD 122 of the camera apparatus 1.

In the camera apparatus 1, for example, recording area 122-1 is preliminarily partitioned (dimensioned) to have a capacity in which “4.7 GB” data for “DVD-R” disk can be recorded. If the record medium assumed to record the transferred (i.e., “Quick filing”) data is the memory card 123 which can be loaded in or unloaded from the camera apparatus 1, the capacity of the recording area 122-1 is defined to be equal to the capacity of the memory card 123 prepared by the user, for example, “256 MB”. The capacity of the recording area 122 is set at “650 MB” for a CD-R disk or “15 GB” for a HD DVD disk which has proceeded toward practical utilization. It is also possible to set the (primary) recording area 122-1 for, for example, a “DVD-R” disk and allocate the secondly recording area 122-2 for, for example, the memory card 123 (or thirdly and following recording areas 122-3 to 122-n for recording mediums of different capacities) in addition to the secondly recording area 122-2.

In the camera apparatus 1, for example, it is also possible to virtually copy the recording area of the HDD 122 without partitioning the area in accordance with the assumed record medium or allocate the recording area of the HDD 122 in accordance with the capacity of the record medium M (M denotes an optical disk such as the DVD disk, the CD-R disk or the HD DVD) to record the transferred (filing) data, as schematically shown in FIG. 5.

Namely, a database file 122-D is provided in the recording area of the HDD 122 and a data group to be copied or transferred (i.e., for filing), of the data groups recorded in the HDD 122, is recorded in the database file 122-D. Simultaneously, the data size of the data groups as already recorded is recorded (into the database file 122-D).

On the other hand, the capacity (size) to be virtually allocated, according to the record medium recording the data to be copied or transferred (i.e., for filing), is recorded in the database file 122-D. Every time the data groups are added to the database file 122-D, the capacity is calculated and compared with the virtually allocated capacity.

Thus, by preparing the database file 122-D in the HDD 122, the data area of the size enough to record the data transferred by “Quick filing” can be virtually allocated in the HDD 122.

The image data of the images (still images or moving images) shot by the camera apparatus 1 is stored in the (primary) recording area 122-1 of the HDD 122 under predetermined rules. In the (primary) recording area 122-1, “image file (folder)” and “album (folder management unit)” preliminarily defined to separately store the image data under arbitrary conditions may be formed. In this case, the images are stored in the “folder” and “album” designated prior to shooting.

If the total size of the images shot by the camera apparatus 1 is equal to the size of the recording area prepared by assuming the transfer of the image data groups from the HDD 122 in the camera apparatus 1 to another record medium as shown in FIG. 4 and FIG. 5 or if the remaining capacity of the recording area is smaller than a predetermined value, for example, a message “remaining capacity for Quick filing area is small” or “Transfer image data by Quick filing” is displayed on the LCD 22 of the camera apparatus 1 via the video I/F/OSD processor 105.

The size of the recording area shown in FIG. 4 and FIG. 5 is set arbitrarily, by the user, on the “menu screen (used to input various settings)” of the camera apparatus 1, though not described here.

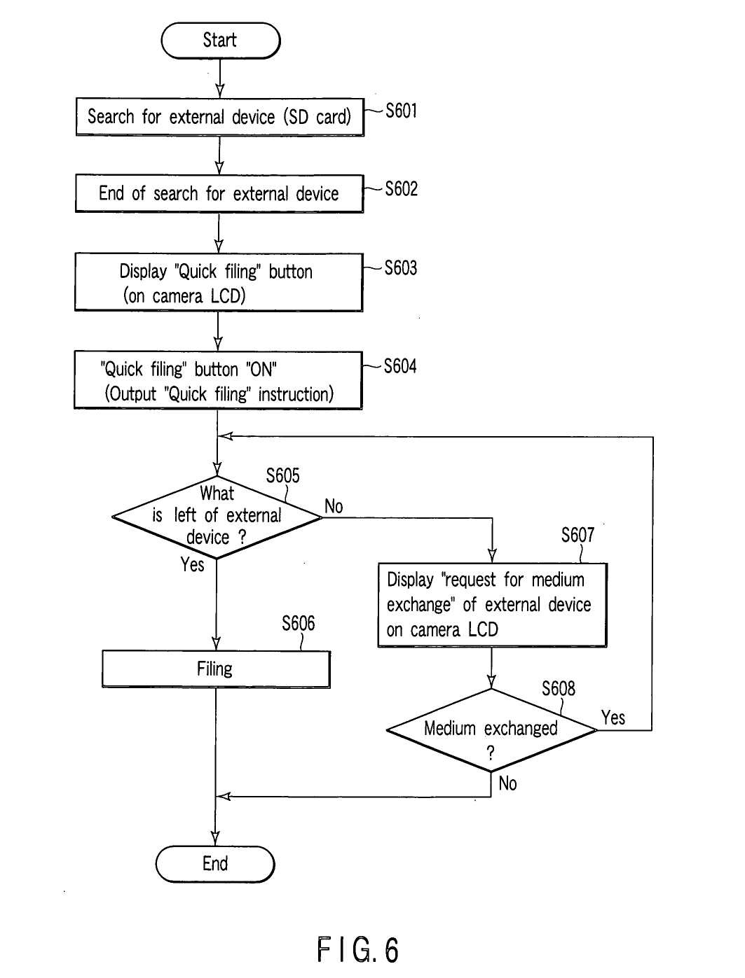

The details of “Quick filing” are described below with reference to a flow shown in FIG. 6.

In FIG. 6, the management device (personal computer; hereinafter called PC (FIG. 2)) and the camera apparatus 1 are connected via the cradle 201, by the cable or radio signals. Otherwise, the connection of the camera apparatus 1 and the PC 221 is selected by the operation of the cradle 221 while the camera apparatus 1 and the PC 221 have already been connected. Thus, a device detector which is application software preinstalled in the PC 221 is activated. The PC 211 may be connected to the adaptor connector 15 of the camera apparatus 1 with, for example, a USB cable. The PC 221 includes a disk drive unit which can record the information on the widely spread DVD-R disk M.

In the step S601, detecting whether connect or non-connect the camera apparatus 1 to an external device, i.e. an optical disk drive (for example, the PC 221 and/or the writer 211).

Connection with the camera apparatus 1 is detected by the PC 221 in step S601 (S602).

If the connection of the camera apparatus 1 to the PC 221 is detected in step S602, a launcher screen 221-1 is displayed on the monitor (display device) of the PC 221. Simultaneously (or when the connection of the camera apparatus 1 to the PC 221 has been completed in step S602), the “Quick filing” button 22-201 as shown in FIG. 2 is displayed on the LCD 22 of the camera apparatus 1 (S603).

The OK button 27 of the camera apparatus 1 (FIG. 1B) is operated (to touch the “Quick filing” button 22-201), the “Quick filing” button 22-201 (displayed on the LCD 22) is “reversely displayed”, the size of the image data (data groups) (including the “image file (folder)” and “album (folder management unit)” preliminarily defined to separately store the image data under arbitrary conditions) recorded in the HDD 122 of the camera apparatus 1 is output to the PC 221 or the writer 211. The transfer (filing) of the data group for the PC 221 is explained (S604).

By outputting the size of the data group to be transferred (filed) in step S604, the size is compared with the remaining capacity of the optical disk (DVD-R, CD-R or HD DVD) M prepared in the disk drive unit, in the PC 221 (S605).

If the remaining capacity of the optical disk M compared in step S605 and the size of the data groups to be transferred (filed) in the camera apparatus 1 are recordable (S605—Yes), the data groups stored in the HDD 122 of the camera apparatus 1 are transferred to the PC 221 and recorded on the optical disk M prepared in the disk drive unit built in the PC 221. All the data groups do not need to be transferred or recorded at one time, but are transferred to a cache memory (not described) of the PC 221 by unit defined by the PC 221, transferred to the disk drive unit built in the PC 211 at a transfer rate and recorded on the optical disk M (S606).

In step S605, if the size of the data groups to be transferred from the camera apparatus 1 can be recorded on a single optical disk M of the preliminarily defined kind but is greater than the remaining capacity of the optical disk M currently set in the disk drive unit (S605—No), a message such as “remaining capacity for Quick filing area of optical disk M is small”, etc., to request exchange of the optical disk M is displayed on the LCD 22 of the camera apparatus 1 via the video I/F/OSD processor 105 (S607).

In this case, for example, operations of an eject switch (not shown) of the disk drive unit on the PC 221 side or opening/closing of the disk tray is monitored, and it is detected whether or not the optical disk M has been exchanged (S608). If it is detected that the optical disk M has been exchanged or reset (S608—Yes), the remaining capacity of the optical disk M set in the disk drive unit is checked again (S605).

If it cannot be detected whether or not the optical disk M has been exchanged (S608—No), “Quick filing” is terminated (forcefully) after, for example, a predetermined period of time has elapsed. A message such as “Quick filing is terminated due to small remaining capacity for Quick filing area of optical disk M” may be displayed on the LCD 22 of the camera apparatus 1 via the video I/F/OSD processor 105 prior to the termination (S609).

As for “transfer”, “move” (i.e., for filing) for transferring the data groups recorded in the recording area 122-1 (122-2 to 122-n) of the HDD 122 and then erasing the data groups in the recording area 122-1 (122-2 to 122-n), and “copy” for holding the data groups recorded in the recording area 122-1 (122-2 to 122-n) as they are, are defined. The “move” and “copy” can be arbitrarily set (by the user), on the “menu screen” of the camera apparatus 1 though not described.

If the capacity of the area allocated for “Quick filing” in the HDD 122 (in the camera apparatus 1) is equal to the size of the memory card (SD memory medium) 123 (in the camera apparatus 1), the connection with the PC 221 is unnecessary. By the transfer instruction (OK button 27 ON) made by the operation of the OK button 27 in response to the “Quick filing” button 22-201 displayed on the LCD 22 of the camera apparatus 1 at a predetermined timing, the data groups are transferred to the SD memory medium 123 prepared in the camera apparatus 1.

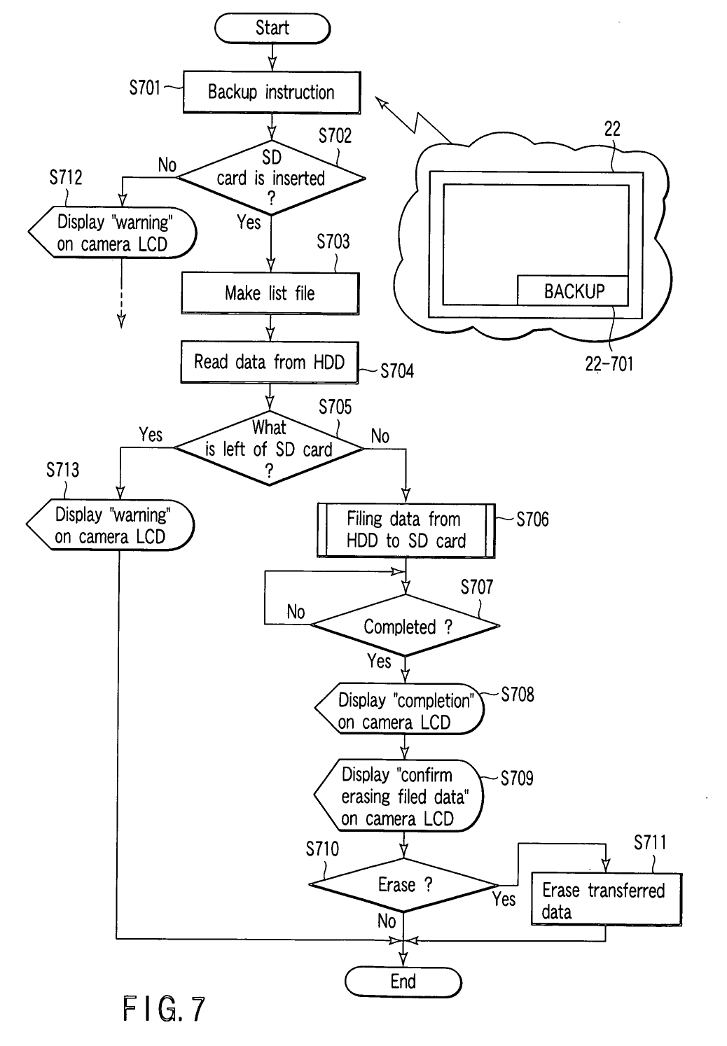

FIG. 7 is a flowchart exemplary showing another method of transferring data group recorded in the recording area shown in FIG. 4 or 5.

For example, when backup button (icon) 22-701 is displayed on the LCD 22 by the video I/F/OSD processor 105 as shown in FIG. 7 or backup is ordered on the menu screen (not described) (S701), it is detected whether or not the SD card 123 is prepared in the camera apparatus 1 (S702). If it is detected in step S702 that the SD card 123 is prepared (S702—Yes), a list file of the image data (data groups) recorded in the HDD 122 is formed in the camera apparatus 1 (S703).

Next, the data (data groups) to be transferred (filed) is read from the HDD 122 and temporarily stored in the main memory 109 or the buffer memory 110 (S704).

The remaining capacity of the SD 123 and the size of the data to be transferred (filed) are compared (S705). If the remaining capacity of the SD 123 is not insufficient (S705—No), the data to be transferred (filed) is transferred (filed) from the HDD 122 to the SD card 123. If the data to be transferred does not need to be buffered temporarily in the buffer memory 110 or main memory 109 in step S704 (for example, if the size of the data to be transferred (filed) is not great), buffering is not definitely necessary (S706).

When the transfer is terminated (S707), for example, a message “transfer terminated” is displayed on the LCD 22 (S708).

For example, a message “erase transferred data in hard disk (HDD)?” is displayed on the LCD 22 of the camera apparatus 1 (S709). If the user orders “erase” (S710—Yes), the transferred data is erased in the HDD 122 (S711).

If the SD card is not prepared in step S702 (S702—No), for example, a message “insert SD card” is displayed on the LCD 22 (S712). If the remaining capacity of the SD card is insufficient in step S705 (S705—Yes), for example, a message “SD card capacity is insufficient” is displayed on the LCD 22 (S713).

In addition, even in a case where the capacity of the area allocated for the “Quick filing” in the HDD 122 (in the camera apparatus 1) matches the capacity of the record medium prepared for the writer 211 which is connectable to the camera apparatus 1, the “Quick filing” can be substantially carried out under the flow shown in FIG. 6.

The embodiment of the invention is applicable, if it is considered that the data groups are reproduced by a playback-only machine which can reproduce the image data on a record medium of specific standards separated from the camera apparatus, steps of the reproduction required for the user having the playback-only machine alone can be simplified.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising:
shooting means for converting an optical image into an electric signal;
display means for displaying an image obtained by the shooting means;
a first record medium which has a first recording capacity and which is detachable from or preliminarily built in the camera apparatus;
a second record medium which has a second recording capacity equal to or smaller than the first record medium and which is detachable from or preliminarily built in the camera apparatus;
setting means for setting a third recording area of a third recording capacity to be at most the second recording capacity of the second record medium, in a recording area of the first record medium; and
transfer controlling means for transferring a data group stored in the third recording area set by the setting means, to the second record medium, as a single unit of the data group stored in the third recoding area.

2. The camera apparatus according to claim 1, wherein the third recording capacity of the third recording area can be arbitrarily set by the setting means.

3. The camera apparatus according to claim 1, wherein the data group held in the third recording area is transferred to the second record medium by one operation.

4. The camera apparatus according to claim 1, wherein a button for outputting a control signal to transfer the data group held in the third recording area to the second record medium by one operation is provided.

5. The camera apparatus according to claim 1, wherein the second record medium includes an external recording device connected thereto in a network or by a serial bus.

6. The camera apparatus according to claim 1, wherein a size of the data group recorded in the third recording area of the third record medium is monitored and it can be informed that the remaining capacity of the third record medium is equal to the capacity of the second recording area or reaches a predetermined value.

7. The camera apparatus according to claim 4, wherein it can be arbitrarily selected whether or not the data transferred to the second record medium by the button should be erased in the first record medium.

8. A data transfer method comprising:
allocating a predetermined size of a recording area for transfer, in a recording device held in a camera apparatus;
storing data groups of shot images sequentially in the recording area for transfer; and
transferring the data groups stored in the recording area for quick filing, by a transfer command which allows the data group to be transferred as a single unit of a data group in the recording area.

9. The method according to claim 8, wherein a command to output the transfer command can be input.
